(19) United States
(12) Patent Application Publication
(10) Pub. No.: US 2008/0157746 A1
(43) Pub. Date: Jul. 3, 2008

(54) Bandgap Reference Circuits

(75) Inventor: Mu-Jung Chen, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/617,991

(22) Filed: Dec. 29, 2006

(51) Int. Cl. G05F 3/16

(52) U.S. Cl. 323/313

(57) ABSTRACT

Bandgap reference circuits capable of preventing start failure. A voltage generation circuit generates a temperature-independent fixed voltage and comprises a current mirror, an operational amplifier, and first and second BJT transistors. A start-up circuit triggers the current mirror until at least one of the first and second BJT transistors operates in a forward-active region when powering on.

### BACKGROUND OF THE INVENTION

1. Field of the Invention

The invention relates to reference circuits, and in particular to bandgap reference circuits capable of preventing start-failure.

2. Description of the Related Art

Analog circuits incorporate voltage and current reference circuits extensively. Such reference circuits are DC quantities that exhibit little dependence on supply and process parameters and a well-defined dependence on temperature. For example, bandgap reference circuits provide popular high performance reference circuits, implementing components with positive temperature coefficient and negative temperature coefficient and add the voltages or current of these components in a predetermined proportion to generate a value independent of temperature, the value output as a reference. Conventional bandgap reference circuits use bipolar technology to create a stable low reference voltage at around 1.25V, almost equal to the silicon energy gap measured in electron volts.

### BRIEF SUMMARY OF THE INVENTION

A detailed description is given in the following embodiments with reference to the accompanying drawings.

Embodiments of bandgap reference circuits are provided, in which a voltage generation circuit comprises a current mirror comprising at least one output terminal, an operational amplifier coupled to the current mirror, and first and second BJT transistors coupled to two input terminals of the operational amplifier respectively. At least one of the first and second BJT transistors is coupled to the output terminal of the current mirror through a conductive path. A start-up circuit triggers the current mirror when powering on, until at least one of the first and second BJT transistors operates in an active region.

The invention provides another embodiment of bandgap reference circuits, in which a voltage generation circuit generates a fixed voltage and comprises a current mirror comprising at least one output terminal, an operational amplifier coupled to the current mirror, and first and second BJT transistors coupled to two input terminals of the operational amplifier respectively. At least one of the first and second BJT transistors is coupled to the output terminal of the current mirror through a conductive path and a start-up circuit is coupled between the current mirror and a node voltage on the conductive path.

The invention provides another embodiment of bandgap reference circuits, in which a voltage generation circuit generates a temperature-independent fixed voltage comprising a current mirror, an operational amplifier, and first and second BJT transistors. A start-up circuit triggers the current mirror until at least one of the first and second BJT transistors operates in a forward-active region when powering on.

The invention also provides an embodiment of a start-up method for bandgap reference circuits, in which the bandgap reference circuit is powered on, and a current mirror in the bandgap reference circuit is triggered, such that at least one diode-connected BJT transistor in the bandgap reference circuit operates in a forward active region.

### BRIEF DESCRIPTION OF THE DRAWINGS

The invention can be more fully understood by reading the subsequent detailed description and examples with references made to the accompanying drawings, wherein:

FIG. 1 shows an embodiment of a bandgap reference circuit;

FIG. 2 shows operating points of the bandgap reference circuit shown in FIG. 1;

FIG. 3 shows another embodiment of a start-up circuit;

FIG. 4 shows another embodiment of a bandgap reference circuit;

FIG. 5 shows another embodiment of a bandgap reference circuit;

FIG. 6 shows V-I curve of the bandgap reference circuit shown in FIG. 5;

FIG. 7 shows another embodiment of a bandgap reference circuit;

FIG. 8 shows a simulated result of the bandgap reference circuits shown in FIG. 7;

FIG. 9 shows another embodiment of a bandgap reference circuit; and

FIG. 10 shows another embodiment of a bandgap reference circuits.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

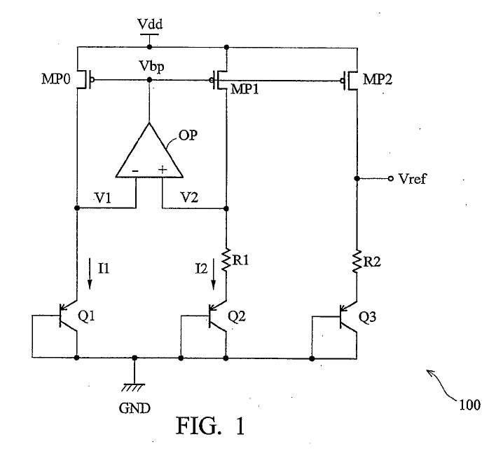

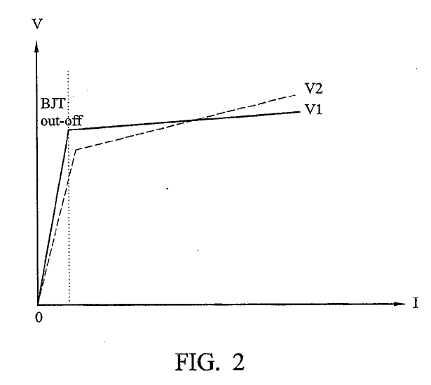

FIG. 1 shows an embodiment of a bandgap reference circuit. As shown, the bandgap reference circuit 100 generates a constant voltage Vref independent from temperature. However, when the voltages V1 and V2 equal 0V at the same time, the operational amplifier OP is turned off and the output voltage Vbp thereof is incorrect, and thus, the feedback control fails accordingly. FIG. 2 shows two operating points of the bandgap reference circuit 100. As shown, the voltages V1 and V2 have two intersects, one at origin (wrong operating point), and the other at the correct operating point. Thus, the bandgap reference circuit 100 requires a start-up circuit to prevent operation at the wrong operating point (origin).

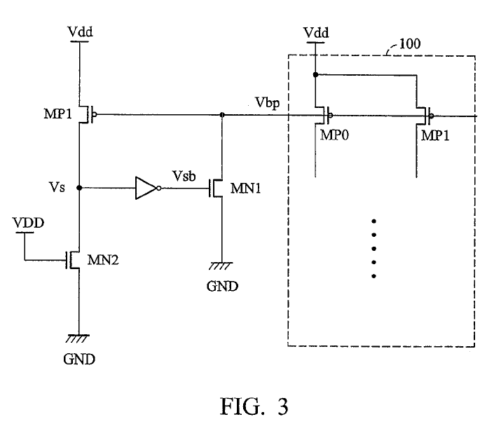

FIG. 3 shows an embodiment of a start-up circuit for bandgap reference circuit. When powering on, the voltages V1 and V2 in bandgap reference circuit 100 equal 0V and |Vdd−Vbp|<|Vtp|, the transistor MN2 is weakly pulled low by the voltage Vdd, such that voltage Vs reaches 0V, voltage Vsb is driven to high logic by the inverter and the voltage Vbp is pulled low by the transistor MN1. Hence, the PMOS transistors MP0˜MP2 are turned on such that the bandgap reference circuit 100 can depart from the wrong operating point (at origin). Further, after the PMOS transistors MP0˜MP2 are turned on, the start-up circuit does not affect the normal operation of the bandgap reference circuit 100 because, after the bandgap reference circuit 100 have departed from the wrong operating point (at origin), the voltage Vs is pulled high and the transistor MN1 is turned off. Thus, the start-up circuit can prevent the bandgap reference circuit 100 from operating at the wrong operating point (origin). However, the reference voltage Vref provided by bandgap reference circuit 100 exceeds 1.2V and is not suitable for low voltage circuits.

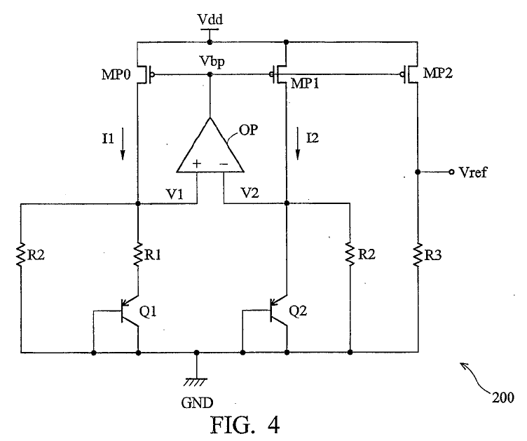

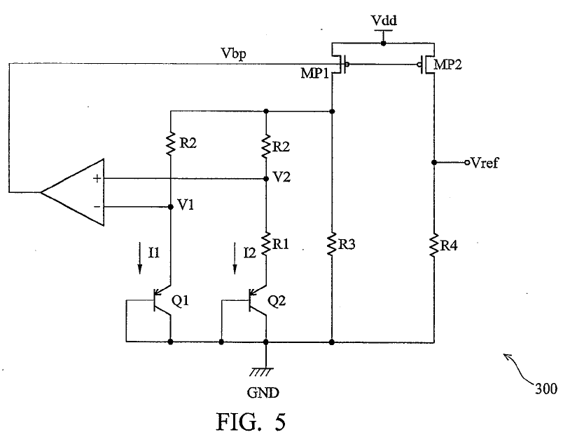

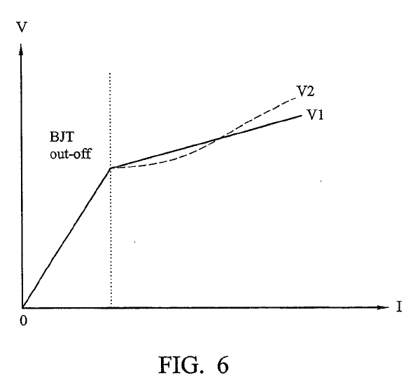

FIG. 4 and FIG. 5 show embodiments of bandgap reference circuits suitable for low voltage circuits. The bandgap reference circuits 200 and 300 have many wrong operating points. For example, in the bandgap reference circuit 200, when the voltages V1 and V2 equal 0V and the transistors Q1 and Q2 operate in cut-off region, the current I1 equals the current I2 due to the output voltage Vbp of the operational amplifier OP. However, the currents I1 and I2 almost flow through the resistor R2 parallel to the transistors Q1 and Q2, such that the transistors Q1 and Q2 are still operated in cut-off region. Similarly, in the bandgap reference circuit 300, the current generated by the PMOS transistor MP1 controlled by the voltage Vbp almost flows through the resistor R3 parallel to the transistors Q1 and Q2, such that the transistors Q1 and Q2 are still operated in cut-off region. FIG. 6 shows V-I curve of the bandgap reference circuits suitable for low voltage circuits. Wrong operating points exist not only at the origin point, but also at the entire region where BJT transistors are cut off. The bandgap reference circuits are operated in a correct operating point only if the base-emitter junctions of the transistors Q1 and Q2 are operated in a forward bias region. Further, it is possible that the start-up circuit becomes turned off before the bandgap reference circuits reach the correct operating point because of Vdd rise time and the conversion time (from low to high) of voltage Vs when powering on. Thus, the start-up circuit shown in FIG. 3 is not suitable for low voltage bandgap reference circuits.

In order to prevent bandgap reference circuits from start-failure, a start-up circuit is used to trigger the current mirror when powering on until at least one BJT transistor operating in an active region.

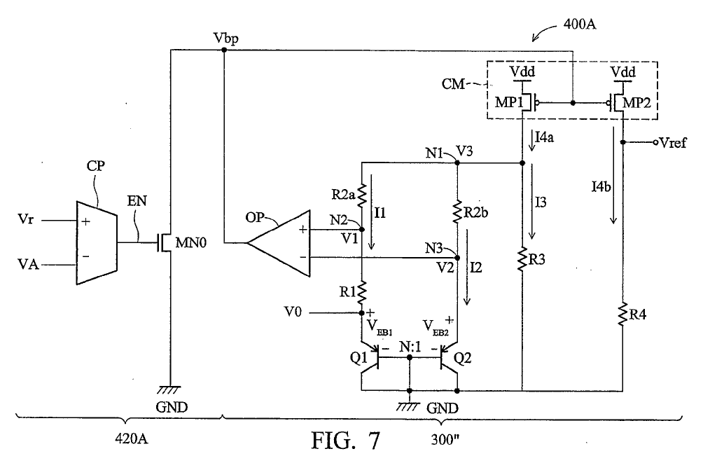

FIG. 7 shows an embodiment of a bandgap reference circuit 400A comprising a voltage generation circuit 300″ and a start-up circuit 420A. The current generation circuit 300″ generates two identical output currents 14a and 14b, and the current 14b can be obtained by combining currents I1, I2 and I3 since the currents 14a and 14b are identical. An output voltage Vref is generated according to the current 14b.

The circuit generation circuit 300″ comprises a current mirror CM, an operating amplifier OP, resistors R1, R2a, R2b and R3, and two bipolar transistors Q1 and Q2, in which the current mirror CM comprises two PMOS transistors MP1 and MP2 and the resistors R2a and R2b have the same resistance. The transistors MP1 and MP2 can be the same size, and the emitter area of the transistor Q1 can be N times that of the transistor Q2, in which N>1. In this case, the resistor R4 serves as a current-to-voltage generator but is not limited thereto, and the current-to-voltage generator can be a resistive element, a passive element or combinations thereof.

The transistor MP1 comprises a first terminal coupled to a power voltage Vdd, a second terminal coupled to a node Ni, and a control terminal coupled to the transistor MP2. The transistor MP2 comprises a first terminal coupled to the power voltage Vdd, a control terminal coupled to the control terminal of the transistor MP1 and a second terminal coupled to the resistor R4. The resistor R3 is coupled between the node N1 and a ground voltage GND, the resistor R2a is coupled between the nodes N1 and N2, the resistor R2b is coupled between the nodes N1 and N3, and the resistor R1 is coupled between the node N2 and the transistor Q1.

The operational amplifier comprises a first terminal coupled to the node N2 and a second terminal coupled to the node N3, and an output terminal coupled to the control terminals of the transistors MP1 and MP2 in the current mirror CM. The operational amplifier OP outputs a control signal to control the current mirror CM according to the voltages at the nodes N2 and N3.

The transistor Q1 comprises an emitter coupled to the resistor R1 and a collector coupled to the ground voltage GND and a base coupled to the transistor Q2. The transistor Q2 comprises an emitter coupled to the node N3 and a collector coupled to the ground voltage GND and a base coupled to the base of the transistor Q1. In this case, the bases of the transistor Q1 and Q2 are coupled to the ground voltage GND. Namely, the transistors Q1 and Q2 are diode-connected transistors.

If the base current is neglected, the emitter-base voltage V_{EB} of a forward active operation diode can be expressed as:

$${V}_{EB} = \frac{kT}{q} ln ( \frac{{I}_{C}}{{I}_{S}} )$$

Wherein k is Boltzmannis constant (1.38×10⁻²³ J/K), q is the electronic charge (1.6×10⁻²⁹ C), T is temperature, I_{C} is the collator current, and I_{S} is the saturation current.

When the input voltages V1 and V2 of the operational amplifier OP are matched and the size of the transistor Q1 is N times that of the transistor Q2, the emitter-base voltage difference between the transistors Q1 and Q2, ΔV_{EB}, becomes:

$$Δ {V}_{EB} = {V}_{EB 2} - {V}_{EB 1} = \frac{kT}{q} ln N$$

Wherein V_{EB1 i}s the emitter-base voltage of the transistor Q1, and V_{EB2} is the emitter-base of the transistor Q2.

Because the input voltages V1 and V2 are matched by the operational amplifier OP, the voltages V1 and V2 can be expressed as:

$$V 1 = V 2 = {V}_{EB 2} = {V}_{EB 1} + I 1 \times R 1$$

$$I 1 \times R 1 = {V}_{EB 2} - {V}_{EB 1} = \frac{kT}{q} ln N$$

Thus, the current I1 through the resistors R2a and R1 can be expressed as:

$$I 1 = \frac{{V}_{T}}{R 1} ln N ,$$

wherein thermal voltage

$${V}_{T} = \frac{kT}{q} .$$

Because the resistors R2a and R2b are identical and the input voltages V1 and V2 are matched by the operational amplifier OP, the current I2 can be the same as the current I1.

$$I 1 = I 2 = \frac{{V}_{T}}{R 1} ln N ,$$

Accordingly, since the thermal voltage V_{T} has a positive temperature coefficient of 0.085 mV/° C., and the currents I1 and I2 have positive temperature coefficient.

Thus, voltage V3 at the node N1 can be expressed as:

V3=I3×R3=I1×(R1+R2a)+V_{EB1}=I2×R2b+V_{EB2}

Hence, the current 13 can be expressed as:

$$I 3 = \frac{1}{R 3} [ {V}_{EB 2} + ( \frac{{V}_{T} ln N}{R 1} \times R 2 b ) ]$$

Because the emitter-base voltage V_{EB} of transistors has a negative temperature coefficient of −2 mV/° C., the current I3 has a negative temperature coefficient.

As the transistors MP1 and MP2 in the current mirror CM are identical, the current I4b is the same as the current I4a, and can be expressed as:

$$\begin{matrix}I 4 a = I 4 b \\ = I 1 + I 2 + I 3 \\ = 2 I 1 + I 3 \\ = ( \frac{2}{R 1} + \frac{R 2 b}{R 1 \times R 3} ) \times {V}_{T} ln N + \frac{{V}_{EB 2}}{R 3}\end{matrix}$$

Hence, if a proper ratio of resistances of the resistors R1, R2a, R2b and R3 is selected, the current I4a will have a nearly-zero temperature coefficient and low sensitivity to temperature. Namely, each current mirror output (currents I4a and I4b) of the current mirror CM will have a nearly-zero temperature coefficient and low sensitivity to temperature.

Accordingly, the output voltage of the bandgap reference circuit 400A can be expressed as:

$$\begin{matrix}{V}_{ref} = I 4 b \times R 4 \\ = ( \frac{2 R 4}{R 1} + \frac{R 2 b \times R 4}{R 1 \times R 3} ) \times {V}_{T} ln N + \frac{R 4}{R 3} \times {V}_{EB 2}\end{matrix}$$

Without the resistor R3, the output voltage Vref of the bandgap reference circuit is limited to 1.25V, which cannot be operated in low voltage environments, in order to obtain a nearly-zero temperature coefficient. Thus, the resistor R3 is used to induce the current 13 with negative temperature coefficient to overcome such limitation, and if a proper ratio of resistances of the resistors R1, R2a, R2b, R3 and R4 is selected, the output voltage Vref will have low sensitivity to temperature and can be operated in low voltage environments.

As shown in FIG. 7, the start-up circuit 420A comprises a comparator CP and a NMOS transistor MN0. The transistor MN0 comprises a first terminal coupled to the control terminals of the transistor MP1 and MP2, a second terminal coupled to the ground voltage, and a control terminal coupled to output terminal of the comparator CP. The comparator CP comprises two input terminals coupled to a reference voltage Vr and a detection voltage VA respectively, and an output terminal coupled to the control terminal of the transistor MN0. The reference voltage Vr is equal to or less than the threshold voltage of the transistors Q1 and Q2. Namely, the reference voltage Vr is not greater than threshold voltage of transistors Q1 and Q2. The detection voltage VA can be a node voltage on a conductive path between one BJT transistor (Q1 or Q2) and the output terminal of the current mirror CM. For example, the detection voltage VA can be voltage V0 at emitter of the transistor Q1, voltage V1 at non-inversion input terminal of the operational amplifier OP, voltage V2 at inversion input terminal of the operational amplifier OP or voltage V3 at node N1, or a voltage on a tap of the resistors R1, R2a or R2b.

When the bandgap reference circuit 400A is powered on, the comparator CP in the start-up circuit 420A compares the reference voltage Vr and the detection voltage VA and outputs an enabling signal EN with high level to the transistor MN0 when the detection voltage VA does not exceed the reference voltage Vr. Namely, start-up circuit 420A pulls low the voltage Vbp by the transistor MN0 to trigger the current mirror CM when the detection voltage VA is smaller than the reference voltage Vr after powering on. When the detection voltage VA exceeds the reference voltage Vr, the comparator CP stops outputting the enabling signal EN, such that the transistor MN0 is turned off and the current mirror CM is controlled by output of the operational amplifier OP.

When the detection voltage VA exceeds the reference voltage Vr which is not greater than threshold voltage of transistors Q1 and Q2, at least one of the transistors Q1 and Q2 is operated in a forward active region. Namely, the start-up circuit 420A triggers the current mirror CM until at least one BJT transistor operates in an active region, such that the bandgap reference circuit 400A can start up successfully.

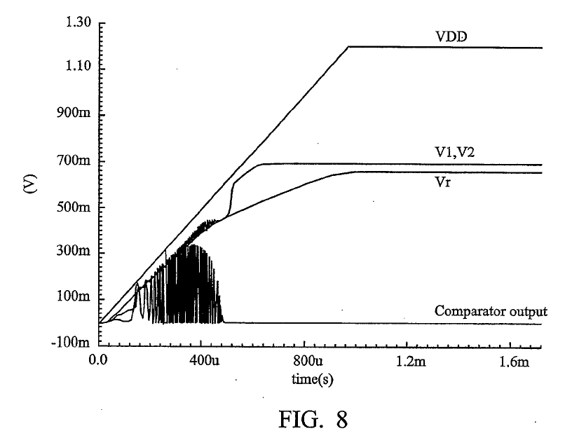

FIG. 8 shows a simulated result of the bandgap reference circuits 400A. As shown, the comparator CP outputs signals to trigger the current mirror CM when the voltage V1 or V2 is smaller than the reference voltage Vr until the transistors Q1 and Q2 are operated in a forward-active region. Thus, the bandgap reference circuit 400A can start up successfully.

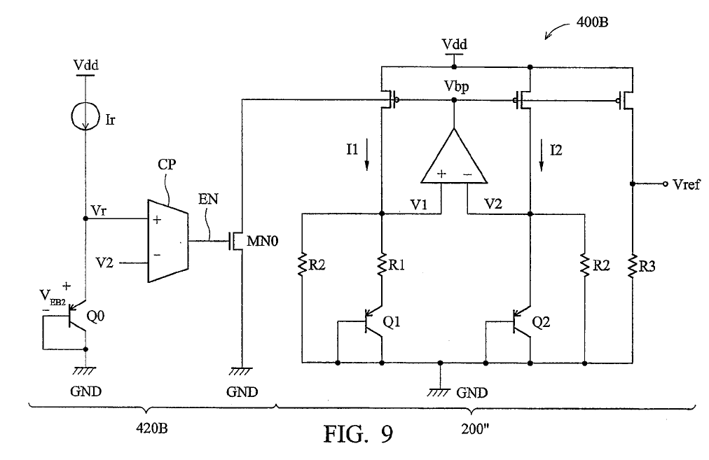

FIG. 9 shows another embodiment of a bandgap reference circuit. As shown, the bandgap reference circuit 400B comprises a voltage generation circuit 200″ and a start-up circuit 420B. In the embodiment, the bandgap reference circuit 200 shown in FIG. 4 is used to serve as the voltage generation circuit 200″, generating a temperature-independent fixed voltage Vref. The input terminals of the comparator CP generate the enabling signal En according to the reference voltage Vr and the voltage V2 on the inversion input terminal of the operational amplifier OP. In this embodiment, the reference voltage Vr is generated by the fixed current source Ir and the transistor Q0. Operation of the start-up circuit 420B is similar to that of the bandgap reference circuit 400A shown in FIG. 7, and thus are omitted for simplification.

Preferably, the reference voltage Vr equals the voltage V_{EB0} at the emitter of the transistor Q0 and the current provided by the fixed current source Ir is less than that through the transistors Q1 and Q2, such that the voltage Vr and the voltage V2 have the same temperature coefficient. Thus, the bandgap reference circuit 400B can start up successfully when the power voltage Vdd exceeds threshold voltage of the transistors Q0˜Q2, regardless of rising time of the power voltage Vdd.

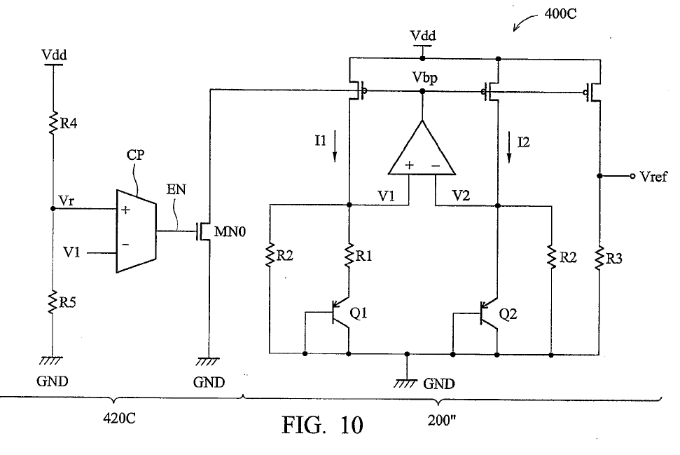

FIG. 10 shows another embodiment of a bandgap reference circuit 400C, similar to the circuit 400B shown in FIG. 9 except for the start-up circuit 420C. The reference voltage Vr is generated by voltage-divide. For example, the resistor R4 is coupled between the power voltage and one input terminal of the comparator CP and the resistor R5 is coupled between the input terminal of the comparator CP and the ground voltage GND. Operation of the start-up circuit 420C is similar to those in the bandgap reference circuit 400A shown in FIG. 7, and thus are omitted for simplification.

The bandgap reference circuits 100˜300 and 400A˜400C of the invention can act as a necessary functional block for the operation of mixed-mode and analog integrated circuits (ICs), such as data converters, phase lock-loop (PLL), oscillators, power management circuits, dynamic random access memory (DRAM), flash memory, and much more. For example, the bandgap reference circuit 100˜300 or 400A˜400C provides the fixed current or the output voltage Vref to a core circuit, and the core circuit executes functions thereof accordingly.

The invention also provides a start-up method for a bandgap reference circuit. In the method, when bandgap reference circuit 400A, 400B or 400C is powered on, a current mirror CM in the bandgap reference circuit 400A, 400B or 400C is triggered, such that at least one diode-connected BJT transistor in the bandgap reference circuit 400A, 400B or 400C operates in a forward-active region.

For example, after powering on, the comparator CP compares the reference voltage Vr and a detection voltage VA on a conductive path between an output terminal of the current mirror CM and the transistors Q1 and Q2 and outputs an enabling signal EN with high level to the transistor MN0 when the detection voltage VA does not exceed the reference voltage Vr. Namely, start-up circuit 420A pulls the voltage Vbp by the transistor MN0 to trigger the current mirror CM when the detection voltage VA is smaller than the reference voltage Vr after powering on. The reference voltage Vr is equal to or under the threshold voltage of the transistors Q1 and Q2. Namely, the reference voltage Vr is not greater than threshold voltage of transistors Q1 and Q2.

Further, the detection voltage VA can be a node voltage on a conductive path between one BJT transistor (Q1 or Q2) and the output terminal of the current mirror CM. For example, the detection voltage VA can be voltage V0 at emitter of the transistor Q1, voltage V1 at non-inversion input terminal of the operational amplifier OP, voltage V2 at inversion input terminal of the operational amplifier OP, voltage V3 at node N1, or a voltage on a tap of the resistors R1, R2a or R2b. The reference voltage Vr can be generated by voltage-divide or a combination of a fixed current source and a diode-connected BJT transistor shown in FIG. 9.

When the detection voltage VA exceeds the reference voltage Vr, the comparator CP stops outputting the enabling signal EN, such that the transistor MN0 is turned off and the current mirror CM is controlled by output of the operational amplifier OP. Namely, the start-up circuit 420A, 420B or 420C triggers the current mirror CM until at least one BJT transistor operates in an active region, such that the bandgap reference circuit 400A can start up successfully.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bandgap reference circuit, comprising:
a voltage generation circuit comprising:
a current mirror comprising at least one output terminal;
an operational amplifier coupled to the current mirror;
first and second BJT transistors coupled to two input terminals of the operational amplifier respectively, wherein at least one of the first and second BJT transistors is coupled to the output terminal of the current mirror through a conductive path; and
a start-up circuit triggering the current mirror;
wherein when powering on, the start-up circuit triggers the current mirror until at least one of the first and second BJT transistors operates in a forward-active region.

2. The bandgap reference circuit as claimed in claim 1, wherein the start-up circuit triggers the current mirror according to a reference voltage and a node voltage on the conductive path.

3. The bandgap reference circuit as claimed in claim 2, wherein the start-up circuit comprises:
a switching transistor comprising a first terminal coupled to a control terminal of the current mirror, and a second terminal coupled to a first power voltage; and
a comparator turning on the switching transistor to trigger the current mirror when the node voltage on the conductive path does not exceed the reference voltage.

4. The bandgap reference circuit as claimed in claim 3, wherein the start-up circuit further comprises voltage-divided circuit coupled between the first power voltage and a second power voltage, generating the reference voltage.

5. The bandgap reference circuit as claimed in claim 3, wherein the start-up circuit further comprises:
a fixed current source coupled between a second power voltage and a connection node; and
a third BJT transistor comprising an emitter coupled to the connection node and a collector coupled to the first power voltage, and an emitter voltage thereof serving as the reference voltage.

6. The bandgap reference circuit as claimed in claim 5, wherein the first, second, and third BJT transistors are diode-connected.

7. The bandgap reference circuit as claimed in claim 2, wherein the start-up circuit triggers the current mirror according to a reference voltage and an emitter voltage of one of the first and second BJT transistors.

8. The bandgap reference circuit as claimed in claim 2, wherein the start-up circuit triggers the current mirror according to a reference voltage and a voltage on one of the two input terminals of the operational amplifier.

9. The bandgap reference circuit as claimed in claim 2, wherein the start-up circuit triggers the current mirror when the node voltage on the conductive path does not exceed the reference voltage.

10. The bandgap reference circuit as claimed in claim 9, wherein the reference voltage is not less than threshold voltage of the first and second BJT transistors.

11. A bandgap reference circuit, comprising:
a voltage generation circuit generating a fixed voltage and comprising:
a current mirror comprising at least one output terminal;
an operational amplifier coupled to the current mirror;
first and second BJT transistors coupled to two input terminals of the operational amplifier respectively, wherein at least one of the first and second BJT transistors is coupled to the output terminal of the current mirror through a conductive path; and
a start-up circuit coupled between the current mirror and a node on the conductive path.

12. The bandgap reference circuit as claimed in claim 11, wherein the start-up circuit comprises:
a comparator comprising two input terminals coupled to the node on the conductive path and a reference voltage; and
a switching transistor coupled between a first power voltage and a control terminal of the current mirror, the switching transistor comprising a control terminal coupled to an output terminal of the comparator.

13. The bandgap reference circuit as claimed in claim 12, wherein the input terminals of the comparator are coupled to the reference voltage and an emitter of one of the first and second BJT transistors.

14. The bandgap reference circuit as claimed in claim 12, wherein the input terminals of the comparator are coupled to the reference voltage and a voltage on one of the two input terminals of the operational amplifier.

15. The bandgap reference circuit as claimed in claim 12, wherein the reference voltage is not greater than threshold voltage of the first and second BJT transistors.

16. A bandgap reference circuit, comprising:
a voltage generation circuit generating a temperature-independent fixed voltage and comprising a current mirror, an operational amplifier and first and second BJT transistors; and
a start-up circuit triggering the current mirror until at least one of the first and second BJT transistors operates in a forward-active region when powering on.

17. The bandgap reference circuit as claimed in claim 16, wherein the start-up circuit triggers the current mirror according to a reference voltage and a node voltage on a conductive path between an output terminal of the current mirror and at least one of the first and second BJT transistors.

18. The bandgap reference circuit as claimed in claim 17, wherein the start-up circuit triggers the current mirror according to a reference voltage and an emitter voltage of one of the first and second BJT transistors.

19. The bandgap reference circuit as claimed in claim 17, wherein the start-up circuit triggers the current mirror according to a reference voltage and a voltage on an inversion input terminal or a non-inversion input terminal of the operational amplifier.

20. The bandgap reference circuit as claimed in claim 17, wherein the reference voltage is not greater than threshold voltage of the first and second BJT transistors.

21. The bandgap reference circuit as claimed in claim 17, wherein the start-up circuit triggers the current mirror when the node voltage on the conductive path does not exceed the reference voltage.

22. The bandgap reference circuit as claimed in claim 17, wherein the reference voltage is generated by a voltage-divided circuit coupled between a first power voltage and a second power voltage.

23. The bandgap reference circuit as claimed in claim 17, wherein the reference voltage is generated by a fixed current source and a third BJT transistor.

24. The bandgap reference circuit as claimed in claim 17, wherein the start-up circuit comprises a comparator generating an enable signal when the node voltage on the conductive path does not exceed the reference voltage, triggering the current mirror until the first or the second BJT diode-connected transistors operates in the forward-active region.

25. The bandgap reference circuit as claimed in claim 24, wherein the start-up circuit further comprises a switching transistor comprising a first terminal coupled to a control terminal of the current mirror, and a second terminal coupled to a first power voltage, and a control terminal coupled to the enabling signal.

26. A start-up method for a bandgap reference circuit, comprising:
powering on the bandgap reference circuit; and
triggering a current mirror in the bandgap reference circuit, such that at least one diode-connected BJT transistor in the bandgap reference circuit operates in a forward active region.

27. The start-up method as claimed in claim 26, wherein triggering the current mirror in the bandgap reference circuit comprises:
comparing a reference voltage and a node voltage on a conductive path between an output terminal of the current mirror and at least one of the diode-connected BJT transistors; and
triggering the current mirror when the node voltage on the conductive path does not exceed the reference voltage.

28. The start-up method as claimed in claim 26, wherein the reference voltage is not greater than threshold voltage of the diode-connected BJT transistor.

29. The start-up method as claimed in claim 26, wherein the node voltage is an emitter voltage of the diode-connected BJT transistor.

30. The start-up method as claimed in claim 26, wherein the node voltage is a voltage on an inversion input terminal or a non-inversion input terminal of the operational amplifier coupled to the diode-connected BJT transistor.

31. A start-up method for a bandgap reference circuit, comprising:
powering on the bandgap reference circuit;
triggering a current mirror in the bandgap reference circuit to make at least one diode-connected BJT transistor in the bandgap reference circuit reach a forward active region; and
stop the triggering.

32. A start-up method for a bandgap reference circuit, comprising:
powering on the bandgap reference circuit; and
triggering a current mirror in the bandgap reference circuit to make at least one diode-connected BJT transistor in the bandgap reference circuit reach a forward active region;
wherein the triggering is done by a start-up circuit and the start-up circuit is not within a feedback loop of the bandgap reference circuit.
